(19) United States
(12) Patent Application Publication
(10) Pub. No.: US 2010/0017633 A1
(43) Pub. Date: Jan. 21, 2010

(54) MEMORY DEVICE, CONTROL DEVICE FOR MEMORY DEVICE, AND CONTROL METHOD FOR MEMORY DEVICE

(75) Inventor: Hiroaki Inoue, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/569,434

(22) Filed: Sep. 29, 2009

Related U.S. Application Data
(63) Continuation of application No. PCT/JP2007/057810, filed on Apr. 9, 2007.

(51) Int. Cl. G06F 1/32; G06F 12/00

(52) U.S. Cl. 713/320; 711/112; 711/E12.001

(57) ABSTRACT

According to one embodiment, a control device includes: a calculation module acquiring at least one of speed information, and calculating a process time taken to write data group when the acquired speed information is used, each of the speed information corresponding to different swing speed; a selection module selecting one of the speed information based on the acquired speed information and the process time thereof; and a control module controlling a memory medium driving module, controlling the writing module to write the data group when the memory medium driving module is in operation, storing the data group in the memory module when the memory medium driving module is not in operation, controlling the swing module on the basis of the selected speed information, and controlling the writing module to write the data group stored in the memory module.

### CROSS-REFERENCE TO RELATED APPLICATIONS

This application is a continuation of PCT international application Ser. No. PCT/JP2007/057810 filed on Apr. 9, 2007 which designates the United States, incorporated herein by reference the entire contents of which are incorporated herein by reference.

### BACKGROUND

1. Field

One embodiment of the invention relates to a memory device, a control device for the memory device, and a control method for the memory device for reducing power consumption.

2. Description of the Related Art

Recently, the use of personal computers (PCs) in a mobile environment is increasing with the popularization of notebook PCs. In a mobile environment, a PC operates using only a built-in battery as a power supply, thus requiring a reduction of power consumption.

On the other hand, a magnetic disk device has been widely used as a high-capacity recording medium. However, a typical magnetic disk device needs to continuously rotate a magnetic disk medium by a spindle motor (SPM), thus causing a large amount of power consumption.

A hybrid hard drive has been proposed to reduce large power consumption in a magnetic disk device. The hybrid hard drive may be used as a recording device for storing data, applications, and an operating system (OS) of a notebook PC. The hybrid hard drive has a high-capacity nonvolatile memory in addition to a typical magnetic disk medium. When an SPM is stopped at the command of an OS, the hybrid hard drive temporarily stores write data, generated by a host, in a nonvolatile memory. That is, the hybrid hard drive uses the nonvolatile memory as a cache memory. When the nonvolatile memory is full, the hybrid hard drive drives the SPM to start a write operation (a write-back operation) on the magnetic disk medium. That is, while write data is being stored in the nonvolatile memory, the hybrid hard drive stops the SPM, thus reducing the power consumption.

The nonvolatile memory is a temporary cache region. Therefore, when the nonvolatile memory is full, the hybrid hard drive has to perform a write-back operation on the magnetic disk medium from the nonvolatile memory. In the write-back operation, like the typical magnetic disk device, the hybrid hard drive reorders data for the purpose of a shortest process time on the basis of the physical location relationship on the magnetic disk medium and performs a write operation on the magnetic disk medium.

As a related art of the present invention, there has been a head position determination device that memorizes a fast seek speed profile and a slow seek speed profile in advance to allow a user to select one of the fast seek speed profile and the slow seek speed profile (for example, refer to Japanese Patent Application Publication (KOKAI) No. H5-325446). Also, there has been a magnetic disk device that stops a spindle motor to reduce the power consumption (for example, refer to Japanese Patent (KOKAI) No. 2858542).

However, the typical magnetic disk device requires large power consumption in order to always provide the maximum speed seek in a write operation.

Also, Japanese Patent Application Publication (KOKAI) No. H5-325446 discloses a technique for reducing the power consumption by reducing the seek speed in the typical magnetic disk device where a magnetic disk always rotates.

However, in the case of the magnetic disk device capable of suitably stopping the SPM like the hybrid hard drive, even when the power consumption of a voice coil motor (VCM) moving the head decreases by the decrease of the seek speed, if the power consumption of the SPM increases greatly by the increase of the driving time of the SPM, it is difficult to reduce the power consumption of a write operation as much as the decrease of the seek speed. That is, in the hybrid hard drive, the power consumption in a data write operation has to consider the power consumption of the VCM and the power consumption of the SPM.

Also, the capacity of the memory of the typical magnetic disk device is small, the time taken for a write operation from the memory to the magnetic disk is small. Therefore, the difference in the power consumption according to the difference in the reordering process is ignorable.

However, because the hybrid hard drive has a large-capacity nonvolatile memory, the power consumption of a write operation varies according to the reordering module. Therefore, in a hybrid hard drive operating in a low power consumption environment such as a mobile environment, it is important to reduce the power consumption in a write operation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hybrid hard drive according to an embodiment of the invention;

FIG. 2 is an exemplary flow chart of a first seek mode selection process in the embodiment;

FIG. 3 is an exemplary flow chart of a reordering process in the embodiment;

FIG. 4 is an exemplary conceptual diagram illustrating an execution time in the embodiment;

FIG. 5 is an exemplary graph of the values set in a seek time table in the embodiment;

FIG. 6 is an exemplary graph of the values set in a VCM power consumption table in the embodiment;

FIG. 7 is an exemplary table of the calculation results for the case of using a fast seek mode in the embodiment;

FIG. 8 is an exemplary table of the calculation results for the case of using a slow seek mode in the embodiment;

FIG. 9 is an exemplary flow chart of a second seek mode selection process in the embodiment;

FIG. 10 is an exemplary flow chart of a first seek mode selection process for the case of setting three seek modes in the embodiment; and

FIG. 11 is an exemplary flow chart of a second seek mode selection process for the case of setting three seek modes in the embodiment.

### DETAILED DESCRIPTION

Various embodiments according to the invention will be described hereinafter with reference to the accompanying drawings. In general, according to one embodiment of the invention, a memory device configured to drive a writing module to write data in a memory medium, includes: a memory medium driving module configured to drive the memory medium; a memory module configured to store a data group of a plurality of data to be written in the memory medium; a management module configured to obtain the data group from an upper device, store the data group in the memory module, and manage management information about the data group; a swing module configured to swing the writing module; a calculation module configured to retain a plurality of speed information, acquire at least one of the speed information among the plurality of speed information, and calculate a process time taken to write the data group when the acquired speed information is used, each of the plurality of speed information corresponding to different swing speed of the swing module; a selection module configured to select one of the plurality of speed information based on the acquired speed information and the process time corresponding to the acquired speed information; and a control module configured to control the memory medium driving module, control the writing module to write the data group when the memory medium driving module is in operation, store the data group in the memory module when the memory medium driving module is not in operation, control the swing module based on the selected speed information, and control the writing module to write the data group stored in the memory module.

According to another embodiment of the invention, a control device for a memory device configured to drive a writing module to write data in a memory medium, includes: a management module configured to obtain a data group of a plurality of data to be written in the memory medium from an upper device, store the data group in the memory module, and manage management information about the data group; a calculation module configured to retain a plurality of speed information, acquire at least one of speed information among the plurality of speed information, and calculate a process time taken to write the data group when the acquired speed information is used, each of the plurality of speed information corresponding to different swing speed of a swing module configured to swing writing module; a selection module configured to select one of the plurality of speed information on the basis of the acquired speed information and the process time corresponding to the acquired speed information; and a control module configured to control a memory medium driving module driving the memory medium, control the writing module to write the data group when the memory medium driving module is in operation, store the data group in the memory module when the memory medium driving module is not in operation, control the swing module on the basis of the selected speed information, and control the writing module to write the data group stored in the memory module.

According to still another embodiment of the invention, a control method applied to a memory device configured to drive a writing module to write data in a memory medium, includes: obtaining a data group of a plurality of data to be written in the memory medium from an upper device; storing the data group in the memory module; managing management information about the data group; retaining a plurality of speed information, each of the plurality of speed information corresponding to different speed of a swing module configured to swing the writing module; acquiring at least one of speed information among the plurality of speed information; calculating a process time taken to write the data group when the acquired speed information is used; selecting one of the plurality of speed information on the basis of the acquired speed information and the process time corresponding to the acquired speed information; controlling a memory medium driving module driving the memory medium; controlling the writing module to write the data group when the memory medium driving module is in operation; storing the data group in the memory module when the memory medium driving module is not in operation; controlling the swing module on the basis of the selected speed information; and controlling the writing module to write the data group stored in the memory module.

Exemplary embodiments of the invention provide a control device for a memory device and a hybrid hard drive using a memory device.

The configuration of a hybrid hard drive according to an exemplary embodiment of the invention will be described below in detail.

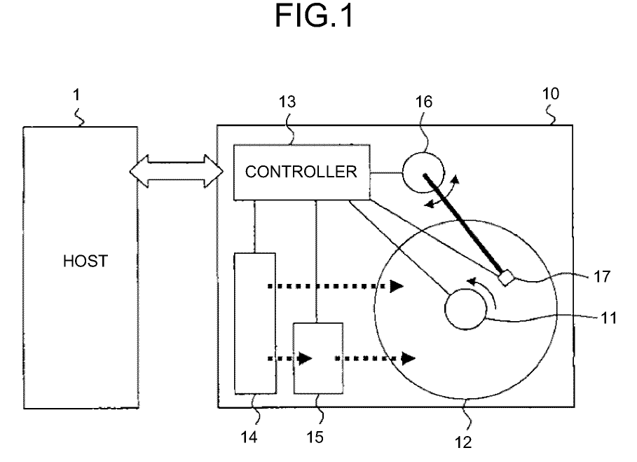

FIG. 1 is a block diagram of a hybrid hard drive according to an exemplary embodiment of the invention. A hybrid hard drive 10 (i.e., a memory device) according to an exemplary embodiment of the invention may comprise a spindle motor (SPM) 11, a magnetic disk medium 12, a controller 13 (i.e., a control device for the memory device), a volatile memory 14, a nonvolatile memory 15, a voice coil motor (VCM) 16, and a head 17. The hybrid hard drive 10 is connected to a host 1.

The SPM 11 is a motor that rotates the magnetic disk medium 12 according to a driving current from the controller 13. The VCM 16 is a motor that moves the head 17 according to a driving current from the controller 13.

The controller 13 controls a driving current for the SPM 11 to control the ON/OFF of the rotation of the magnetic disk medium 12. Also, the controller 13 controls a driving current for the VCM 16 to control a seek speed. The controller 13 has a plurality of seek modes. In the embodiment, the seek modes has a fast seek mode using the highest seek speed and a slow seek mode using a seek speed lower than the highest seek speed. As the seek speed increases, the power consumption of the VCM 16 increases whereas the process time of a write operation decreases and the power consumption of the SPM 11 decreases.

The hybrid hard drive 10 suitably stops the SPM 11 to reduce the power consumption of the device. Therefore, unlike the typical magnetic disk device, the hybrid hard drive may have to consider the power consumption of the VCM 16 and the power consumption of the SPM 11 with regard to the power consumption of the write operation. Thus, the power consumption of a write operation does not depend merely on a seek speed.

The controller 13 receives a logical block address from the host 1 simultaneously with write data, and converts the received logical block address into a sector number and a track number at a target position in the magnetic disk medium 12. At this point, the controller 13 registers the track number, the sector number, and the address of write data of the nonvolatile memory 15 in a queue, and stores the same in a memory of the controller 13. Also, the controller 13 may store the above queue information in the volatile memory 14.

The volatile memory 14 is a cache memory for reducing the speed difference between the host 1 and the hybrid hard drive 10. The capacity of the volatile memory 14 is approximately 8 MB like the typical magnetic disk device. The capacity of the nonvolatile memory 15 is larger than the capacity of the volatile memory 14. For example, the capacity of the nonvolatile memory 15 is approximately 512 MB to approximately 1 GB.

As described above, the hybrid hard drive 10 has a large-capacity nonvolatile memory that is larger in capacity than a volatile memory of the typical magnetic disk device. Therefore, the power consumption during a write operation in the nonvolatile memory 15 varies according to the reordering module.

The operation of the hybrid hard drive according to the embodiment will be described below in detail.

The controller 13 receives an ON/OFF command for the SPM 11 from an operating system (OS) of the host 1, and controls the SPM 11 according to the received command. According to the ATA interface standard, the host 1 may generate a command to set the length of a time period for rotating the SPM 11 of the hybrid hard drive 10. Hereinafter, the length of the time period will be referred as a host set time.

First, a description will now be given of the concept of an operation of the hybrid hard drive 10, during the rotation of the SPM 11, after the controller 13 receives an ON command for the SPM 11 from the host 1. When the controller 13 receives write data from the host 1, the hybrid hard drive 10 temporarily stores the write data in the volatile memory 14 and writes the data, stored in the volatile memory 14, on the magnetic disk medium 12. At this point, the controller 13 performs the write operation in a fast seek mode, in order to reduce the execution time of the write operation by reducing the power consumption of the write operation.

A description will now be given of the concept of an operation of the hybrid hard drive 10 with the SPM 11 not in operation, after the controller 13 receives an OFF command for the SPM 11 from the host 1. Until the nonvolatile memory 15 becomes full, the controller 13 receives write data from the host 1, temporarily stores the received write data in the volatile memory 14, and transmits the data stored in the volatile memory 14 to the nonvolatile memory 15. When the nonvolatile memory 15 becomes full, the controller 13 performs a first seek mode selection process. In particular, the controller 13 rotates the SPM 11 regardless of the command from the host 1 to select a seek mode, and writes all of the data stored in the nonvolatile memory 15 on the magnetic disk medium 12. Then, the controller 13 stops the SPM 11 again.

In the embodiment, the SPM 11 is stopped if the controller 13 receives an OFF command for the SPM 11 from the host 1. However, the controller 13 may stop the SPM 11 if failing to receive a process request from the host 1 for a predetermined time or after completing a data write-back operation of the nonvolatile memory 15.

A description will now be given of the concept of an operation of the hybrid hard drive 10, when the controller 13 sets a host set time in the host 1. When a host set time is set, the controller 13 performs a second seek mode selection process. In particular, the controller 13 rotates the SPM 11 to select a seek mode, and writes all of the data stored in the nonvolatile memory 15 on the magnetic disk medium 12. Then, the controller 13 stops the SPM 11 after the host set time.

The first seek mode selection process will be described below in detail.

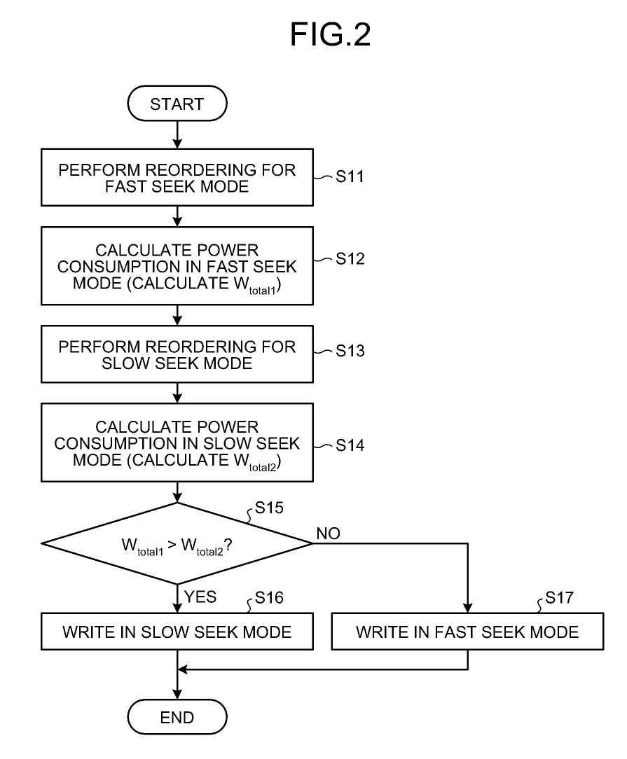

FIG. 2 is a flow chart of a first seek mode selection process according to the embodiment. Referring to FIG. 2, the controller 13 performs a reordering for the case of using a fast seek mode (S11), and performs a power consumption calculation process of calculating the total power consumption Wₜₒₜₐₗ₁ for the case of performing a write operation using the fast seek mode (S12). Thereafter, the controller 13 performs a reordering for the case of using a slow seek mode (S13), and performs a power consumption calculation process of calculating the total power consumption Wₜₒₜₐₗ₂ for the case of performing a write operation using the slow seek mode (S14).

Thereafter, the controller 13 determines whether the total power consumption Wₜₒₜₐₗ₁ is larger than the total power consumption Wₜₒₜₐₗ₂ (Wₜₒₜₐₗ₁>Wₜₒₜₐₗ₂) (S15). If the total power consumption Wₜₒₜₐₗ₁ is larger than the total power consumption Wₜₒₜₐₗ₂ (Yes at S15), the controller 13 performs a write operation using the slow seek mode (S16) and ends the first seek mode selection process. On the other hand, if the total power consumption Wₜₒₜₐₗ₁ is not larger than the total power consumption Wₜₒₜₐₗ₂ (No at S15) the controller 13 performs a write operation using the fast seek mode (S17) and ends the first seek mode selection process.

In the write operation, the controller 13 rotates the SPM 11, controls the VCM 16, and transmits the data stored in the nonvolatile memory 15 to the head 17 to write the same on the magnetic disk medium 12. Also, the controller 13 prestores a seek profile, which represents a change in the driving current of the VCM 16 for each seek mode, in the nonvolatile memory 15 or the like. In the write operation, the controller 13 reads a seek profile corresponding to a selected seek mode, sets the same in a memory of the controller 13, and controls the VCM 16 according to the seek profile.

Also, if the seek mode determined by S15 is identical to the seek mode used in the previous write operation, the controller 13 does not set a new seek profile and performs a write operation using the previous seek profile set in the memory of the controller 13.

The reordering in S11 and S13 will be described below in detail.

When receiving write data from the host 1, the controller 13 registers a queue of the write data in the memory of the controller 13. A queue of when the SPM 11 is not in operation represents the size and the address of write data in the nonvolatile memory 15. A state before a reordering will be referred to as a non-ordered queue, and a queue having an order changed by a reordering will be referred to as an ordered queue. Also, the controller 13 has a seek time table that represents the relationship between a seek distance and a seek time in each seek mode.

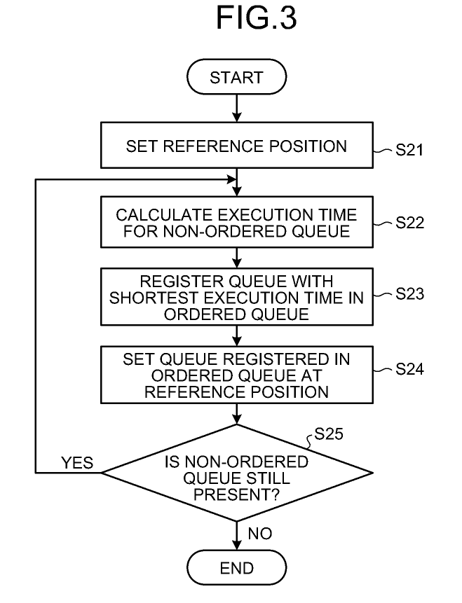

FIG. 3 is a flow chart of the reordering of the embodiment. Referring to FIG. 3, the controller 13 sets the current position of the head 17 (HEAD POSITION) to a reference head position (S21). Thereafter, the controller 13 calculates the execution time of a non-ordered queue with reference to the seek time table (EXECUTION TIME=SEEK TIME+ROTATIONAL WAIT TIME) (S22).

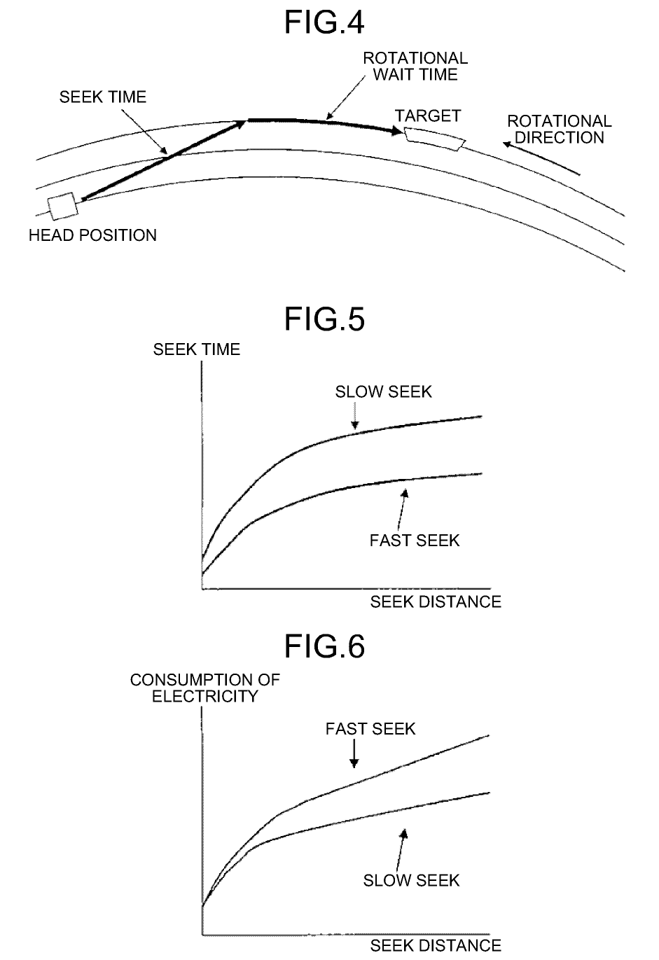

FIG. 4 is a conceptual diagram of an execution time of the embodiment. In S22, the controller 13 calculates a seek time and a rotational wait time with respect to a reference position (HEAD POSITION) and a target position (TARGET) on the magnetic disk medium 12.

Herein, the controller 13 calculates a seek distance from the reference position, the target position, and the seek speed according to the seek mode; and calculates a seek time from the seek distance with reference to seek time table. FIG. 5 is a graph of the values set in a seek time table of the embodiment. In the graph of FIG. 5, the horizontal axis represents the seek distance and the vertical axis represents the seek time. The graph illustrates a curve of a fast seek mode and a curve of a slow seek mode.

Thereafter, the controller 13 registers a queue with the shortest execution time in an ordered queue (S23). Thereafter, the controller 13 sets the queue registered in the ordered queue to the reference position (S24). Thereafter, the controller 13 determines whether a non-ordered queue is still present (S25). If a non-ordered queue is still present (Yes at S25), the controller 13 returns to S21 and performs an operation on a next non-ordered queue. On the other hand, if a non-ordered queue is not present (No at S25), the controller 13 ends the reordering.

The power consumption calculation process in S12 and S14 will be described below in detail.

The controller 13 has a VCM power consumption table that represents the relationship between the seek time and the power consumption of the VCM 16 in each seek mode. FIG. 6 is a graph of the values set in a VCM power consumption table of the embodiment. In the graph of FIG. 6, the horizontal axis represents the seek distance and the vertical axis represents the power consumption (consumption of electricity) of the VCM 16. The graph illustrates a curve of a fast seek mode and a curve of a slow seek mode.

First, the controller 13 calculates the total VCM power consumption W_{vcm}, which is equal to the sum of the power consumption of the VCM 16 in a write operation, from the total seek distance obtained by the reordering with reference to the VCM power consumption table. The total SPM power consumption Wₛ, which is equal to the sum of the power consumption of the SPM 11 in a write operation, is proportional to the total execution time T_{exec} that is the sum of the execution time in a write operation. Therefore, by the following equation, the controller 13 calculates the total SPM power consumption Wₛ from a predetermined proportional coefficient Wₐ and the total execution time T_{exec} obtained by the reordering.

Wₛ=W_{α}×T_{exec}

By the following equation, the controller 13 calculates the total power consumption Wₜₒₜₐₗ that is equal to the sum of the total VCM power consumption W_{vcm} and the total SPM power consumption Wₛ.

Wₜₒₜₐₗ=Wₛ+W_{vcm}

The total power consumption Wₜₒₜₐₗ calculated for the fast seek mode is set to the total power consumption Wₜₒₜₐₗ₁, and the total power consumption Wₜₒₜₐₗ calculated for the slow seek mode is set to the total power consumption Wₜₒₜₐₗ₂.

The calculation results for each seek mode obtained by the first seek mode selection process will be described below in detail.

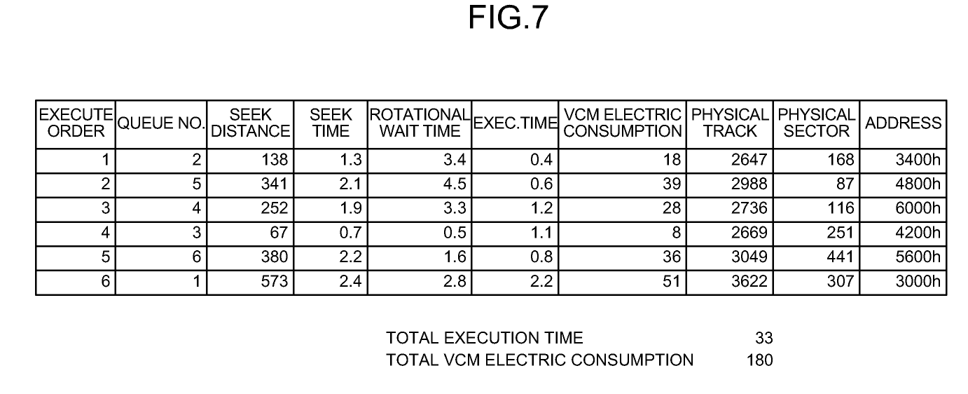

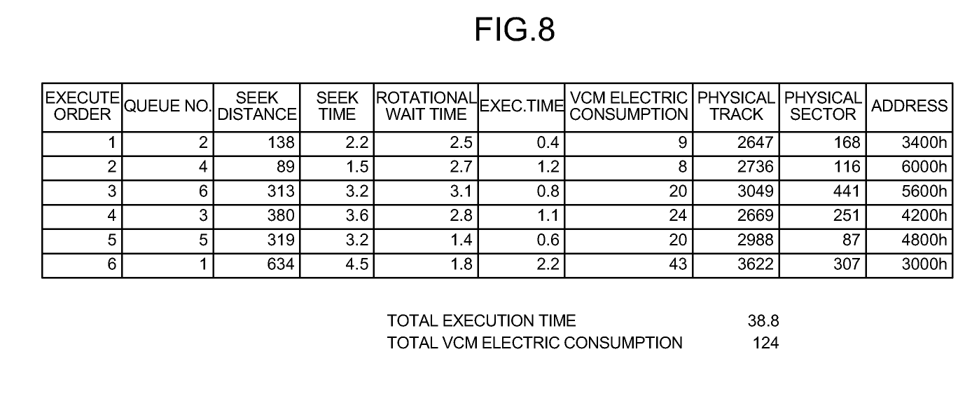

FIG. 7 is a table of the calculation results for the case of using a fast seek mode of the embodiment. FIG. 8 is a table of the calculation results for the case of using a slow seek mode of the embodiment. In the sum results, one row corresponds to one queue. Also, for each queue, the calculation results include the execution order of write operations obtained by the reordering (EXECUTE ORDER), the registration order in queues for reception from the host 1 (QUEUE NO.), the seek distance (SEEK DISTANCE), the seek time (SEEK TIME), the rotational wait time (ROTATIONAL WAIT TIME), the execution time (EXEC. TIME), the VCM power consumption (VCM ELECTRIC CONSUMPTION), the track number of the target position in the magnetic disk medium 12 (PHYSICAL TRACK), the sector number of the target position (PHYSICAL SECTOR), and the address of write data in the nonvolatile memory 15 (ADDRESS).

In addition, the calculation results may further include the total execution time T_{exec} equal to the sum of the execution time of all the queues (TOTAL EXECUTION TIME), and the total VCM power consumption W_{vcm} equal to the sum of the VCM power consumption of all the queues (TOTAL VCM ELECTRIC CONSUMPTION).

Among them, the execution order, the queue No, the seek distance, the seek time, the rotational wait time, the execution time, and the total execution time are obtained by the reordering. The VCM power consumption and the total VCM power consumption are obtained by the power consumption calculation process. The track number, the sector number, and the address are set by the time point of receiving the write data (write command) from the host 1.

According to the calculation results, if a plurality of seek modes are prepared, as the seek speed increases, the total VCM power consumption increases and the total SPM power consumption (the total execution time) decreases. Herein, through the first seek mode selection process, the execution order minimizing the power consumption in each seek mode can be calculated; and the total VCM power consumption, the total SPM power consumption, and the total power consumption can be calculated for each seek mode. Thus, the seek mode minimizing the total power consumption can be selected.

The second seek mode selection process will be described below in detail.

If the host set time is set, the rotation time of the SPM 11 is fixed regardless of the seek mode, so that the total SPM power consumption in the host set time is fixed. Thus, as the seek speed decreases, the total power consumption and the total VCM power consumption in the host set time decrease.

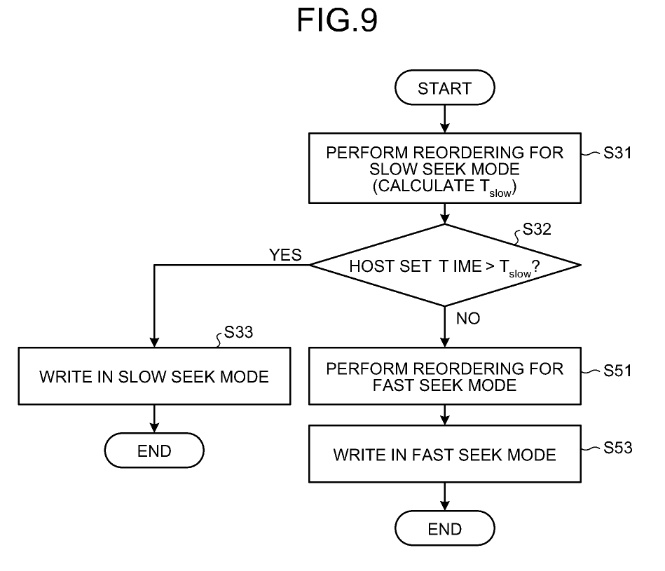

FIG. 9 is a flow chart of a second seek mode selection process of the embodiment. Referring to FIG. 9, if the host set time is set in the host 1, the controller 13 performs a reordering for the case of using a slow seek mode, calculates the total execution time T_{exec}, and sets the same to T_{slow} (S31). Thereafter, the controller 13 determines whether the host set time is greater than T_{slow} (Host Set Time>T_{slow}) (S32).

If the host set time is greater than T_{slow} (Yes at S32) the controller 13 performs a write operation using a slow seek mode (S33) and ends the second seek mode selection process. On the other hand, if the host set time is not greater than T_{slow} (No at S32), the controller 13 performs a reordering process for the case of using a fast seek mode (S51), performs a write operation using a fast seek mode (S53), and ends the second seek mode selection process.

Through the second seek mode selection process, a write operation of all the write data stored in the nonvolatile memory 15 can be completed within the host set time, and the seek mode minimizing the total power consumption can be selected.

If a write operation of all the write data stored in the nonvolatile memory 15 cannot be completed within the host set time by using the selected seek mode, the controller 13 may write only write data writable within the host set time, and may store the remaining write data in the nonvolatile memory 15 until the nonvolatile memory 15 is full.

Although it has been described that the seek modes include the fast seek mode and the slow seek mode, three or more seek speeds may be set and the corresponding seek modes may be set. Hereinafter, a description will be given of the case of setting three seek modes including a fast seek mode, a middle-speed seek mode, and a slow seek mode.

First, a description will be given of a first seek mode selection process for the case of setting three seek modes.

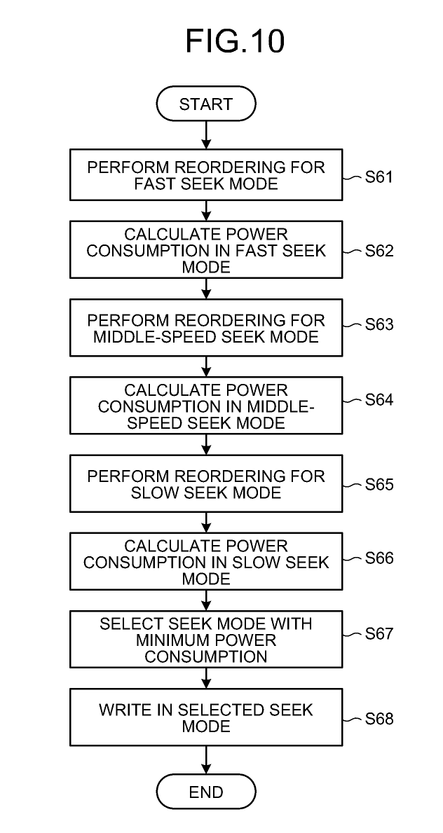

FIG. 10 is a flow chart of a first seek mode selection process for the case of setting three seek modes of the embodiment. Referring to FIG. 10, the controller 13 performs a reordering for the case of using a fast seek mode (S61), and performs a power consumption calculation process of calculating the total power consumption W_{total-fast} for the case of performing a write operation using the fast seek mode (S62). Thereafter, the controller 13 performs a reordering process for the case of using a middle-speed seek mode (S63), and performs a power consumption calculation process of calculating the total power consumption W_{total-mid} for the case of performing a write operation using the middle-speed seek mode (S64). Thereafter, the controller 13 performs a reordering for the case of using a slow seek mode (S65), and performs a power consumption calculation process of calculating the total power consumption W_{total-slow} for the case of performing a write operation using the slow seek mode (S66).

Thereafter, the controller 13 compares the total power consumption W_{total-fast}, the total power consumption W_{total-mid} and the total power consumption W_{total-slow} to select the seek mode minimizing the total power consumption (S67), performs a write operation using the selected seek mode (S68), and ends the first seek mode selection process.

By increasing the number of the seek modes, the total power consumption of the seek mode determined by the first seek mode selection process can approach the minimum value.

Also, the first seek mode selection process performs a reordering and a power consumption calculation process for all the seek modes, and the order of the seek modes for the reordering and the power consumption calculation process may be different from the above order.

Hereinafter, a description will be given of a second seek mode selection process for the case of setting three seek modes.

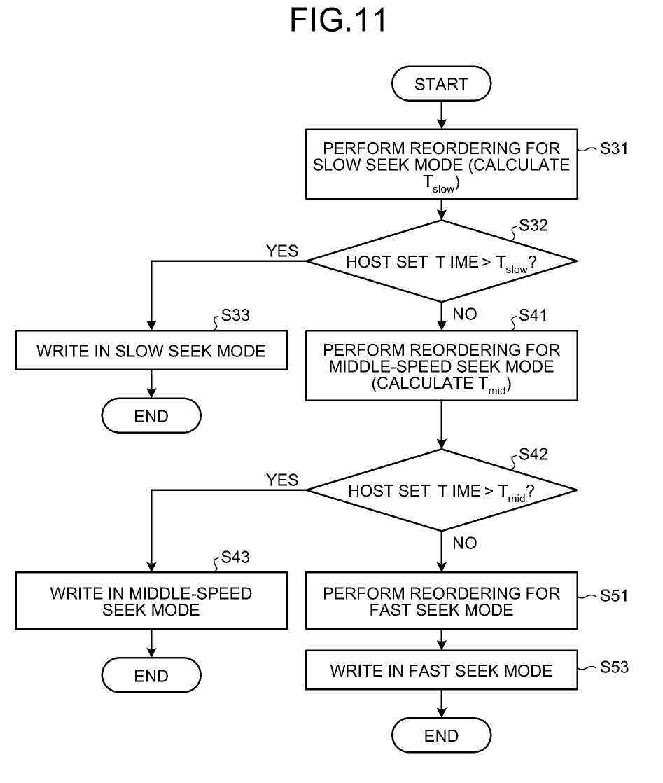

FIG. 11 is a flow chart of a second seek mode selection process in the case of setting three seek modes of the embodiment. In FIGS. 9 and 11, like reference numerals denotes like elements or processes, a detailed description of which will not be repeated.

Referring to FIG. 11, the controller 13 performs a reordering of a slow seek mode (S31). Thereafter, the controller 13 determines whether the host set time is greater than T_{slow} (HOST SET TIME>T_{slow}) (S32). If the host set time is not greater than T_{slow} (No at S32), the controller 13 performs a reordering for the case of using a middle-speed seek mode and calculate the total execution time T_{exec} to set the same to T_{mid} (S41). Thereafter, the controller 13 determines whether the host set time is greater than T_{mid} (HOST SET TIME>T_{mid}) (S42). If the host set time is greater than T_{mid} (Yes at S42), the controller 13 performs a write operation using the middle-speed seek mode (S43), and ends the second seek mode selection process. On the other hand, if the host set time is not greater than T_{mid} (No at S42), the controller 13 performs a reordering for the case of using a fast seek mode (S51), performs a write operation using the fast seek mode (S53), and ends the second seek mode selection process.

By increasing the number of the seek modes, the total execution time of the seek modes determined by the second seek mode selection process can approach the host set time, and the total power consumption can approach the minimum value.

In the second seek mode selection process, by performing the reordering for the seek modes in ascending order of the seek speed, the reordering is unnecessary in the event of a sufficient host set time, thus reducing the reordering.

In S32 and S42, in the case of setting the seek mode of the reordering to a target seek mode, the controller 13 calculates an end time of a write process for the case of using the target seek mode from the total execution time for the case of using the target seek mode to set the same to a write operation end time, and calculates an end time of the host set time to set the same to a host set end time. The controller 13 may determine to perform a write operation using the target seek mode in the case if the host set end time is greater than the write operation end time (HOST SET END TIME>WRITE OPERATION END TIME).

Although a description of the embodiment has been made on the assumption of applying the memory device, the control device, and the control method to a hybrid hard drive, they may be similarly applicable to various recording devices such as a magnetic disk device, an optical disk device, and a magneto-optical disk device. In the embodiment, as the size of a cache memory (a buffer memory) of a memory device corresponding to the nonvolatile memory 15 increases, the power consumption reduction effect increases.

The recording medium corresponds to the magnetic disk medium in the embodiment. Also, the writing module corresponds to the head in the embodiment. The memory module corresponds to the nonvolatile memory in the embodiment. Also, the memory medium driving module corresponds to the SPM in the embodiment. Also, the swing module corresponds to the VCM in the embodiment. Also, the management module, the calculation module, the selection module, and the control module correspond to the controller in the embodiment.

Also, the swing speed corresponds to the seek speed in the embodiment. Also, the speed information corresponds to the seek mode in the embodiment. Also, the process time corresponds to the total execution time in the embodiment. Also, the process order corresponds to the execution order in the embodiment. Also, the management information corresponds to the track number, the sector number, and the address in the embodiment. Also, the power consumption of the memory device corresponds to the total power consumption in the embodiment.

Also, the calculating and the processes of the calculation module correspond to the above S11, S12, S13, S14, S31, S41, S51, S61, S62, S63, S64, S65 and S66 in the embodiment. Also, the selecting and the processes of the selection module correspond to the above S15, S32, S42 and S67 in the embodiment. Also, the controlling and the processes of the control module correspond to the above S16, S17, S33, S43, S53 and S68 in the embodiment.

As described above, the use of the invention makes it possible to reduce the power consumption of a write operation from a cache to a memory medium in a memory device.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory device configured to drive a writing module to write data in a memory medium, comprising:
a memory medium driving module configured to drive the memory medium;
a memory module configured to store a data group of a plurality of data to be written in the memory medium;
a management module configured to obtain the data group from an upper device, store the data group in the memory module, and manage management information about the data group;
a swing module configured to swing the writing module;
a calculation module configured to retain a plurality of speed information, acquire at least one of the speed information among the plurality of speed information, and calculate a process time taken to write the data group when the acquired speed information is used, each of the plurality of speed information corresponding to different swing speed of the swing module;
a selection module configured to select one of the plurality of speed information based on the acquired speed information and the process time corresponding to the acquired speed information; and
a control module configured to control the memory medium driving module, control the writing module to write the data group when the memory medium driving module is in operation, store the data group in the memory module when the memory medium driving module is not in operation, control the swing module based on the selected speed information, and control the writing module to write the data group stored in the memory module.

2. The memory device of claim 1, wherein
the calculation module calculates a writing order of the plurality of data for the case of using the acquired speed information on the basis of the management information and the acquired speed information; and
the control module controls the writing module to write the data group on the basis of the writing order.

3. The memory device of claim 2, wherein
the management information includes a write position of the data group on the memory medium; and
the calculation module calculates the writing order on the basis of the write position and the position of the writing module.

4. The memory device of claim 1, wherein, when the memory medium driving module is not in operation by the control module,
the calculation module calculates the process time for each of the acquired speed information; and
the selection module selects a speed information minimizing the power consumption of the memory device due to writing the data group as the one of the plurality of speed information on the basis of the process time.

5. The memory device of claim 4, wherein the control module controls the memory medium driving module to drive the memory medium, controls the swing module, controls the writing module to write the data group, and controls the memory medium driving module to stop the memory medium.

6. The memory device of claim 4, wherein the calculation module calculates a writing order of the plurality of data for the case of using the acquired speed information on the basis of the management information and the acquired speed information, calculates the process time on the basis of the writing order, calculates the power consumption of the memory medium driving module for the case of using the acquired speed information on the basis of the process time, calculates the power consumption of the swing module on the basis of the writing order, adds the power consumption of the memory medium driving module and the power consumption of the swing module, and determines the addition result as the power consumption of the memory device.

7. The memory device of claim 6, wherein the calculation module retains the relationship between the swing speed, a swing distance by the swing module, and the power consumption of the swing module, calculates the swing distance and the writing order for the case of using the acquired speed information on the basis of the management information and the acquired speed information, and calculates the power consumption of the swing module for the case of using the acquired speed information on the basis of the relationship between the swing distance and the speed information.

8. The memory device of claim 1, wherein, when a driving time taken to drive the memory medium by the memory medium driving module is set by the upper device,
the selection module selects the speed information satisfying a predetermined condition by the process time as the one of the plurality of speed information on the basis of the driving time; and
the control module controls the memory medium driving module to drive the memory medium only for the driving time.

9. The memory device of claim 8, wherein the selection module selects the speed information, which allows the process time to be smaller than or equal to the driving time or to be maximum value, as the one of the plurality of speed information.

10. The memory device of claim 8, wherein
the calculation module acquires the speed information in ascending order of the power consumption of the swing module in of the writing of the data group, and calculates the process time for the case of using the speed information; and
the selection module selects the speed information as the one of the plurality of speed information when the process time for the case of using the speed information is smaller than or equal to the driving time.

11. A control device for a memory device configured to drive a writing module to write data in a memory medium, comprising:
a management module configured to obtain a data group of a plurality of data to be written in the memory medium from an upper device, store the data group in the memory module, and manage management information about the data group;
a calculation module configured to retain a plurality of speed information, acquire at least one of speed information among the plurality of speed information, and calculate a process time taken to write the data group when the acquired speed information is used, each of the plurality of speed information corresponding to different swing speed of a swing module configured to swing writing module;
a selection module configured to select one of the plurality of speed information on the basis of the acquired speed information and the process time corresponding to the acquired speed information; and
a control module configured to control a memory medium driving module driving the memory medium, control the writing module to write the data group when the memory medium driving module is in operation, store the data group in the memory module when the memory medium driving module is not in operation, control the swing module on the basis of the selected speed information, and control the writing module to write the data group stored in the memory module.

12. The control device for the memory device of claim 11, wherein
the calculation module calculates a writing order of the plurality of data for the case of using the acquired speed information on the basis of the management information and the acquired speed information; and
the control module controls the writing module to write the data group stored in the memory module on the basis of the writing order.

13. The control device for the memory device of claim 12, wherein
the management information includes a write position of the data group on the memory medium; and
the calculation module calculates the writing order on the basis of the write position and the position of the writing module.

14. The control device for the memory device of claim 11, wherein, when the memory medium driving module is not in operation by the control module,
the calculation module calculates the process time for each of the acquired speed information; and
the selection module selects a speed information minimizing the power consumption of the memory device due to writing the data group as the one of the plurality of speed information on the basis of the process time.

15. The control device for the memory device of claim 14, wherein the control module controls the memory medium driving module to drive the memory medium, controls the swing module, controls the writing module to write the data group, and controls the memory medium driving module to stop the memory medium.

16. The control device for the memory device of claim 14, wherein the calculation module calculates a writing order of the plurality of data for the case of using the acquired speed information on the basis of the management information and the acquired speed information, calculates the process time on the basis of the writing order, calculates the power consumption of the memory medium driving module for the case of using the acquired speed information on the basis of the process time, calculates the power consumption of the swing module on the basis of the writing order, adds the power consumption of the memory medium driving module and the power consumption of the swing module, and determines the addition result as the power consumption of the memory device.

17. The control device for the memory device of claim 11, wherein, when a driving time taken to drive the memory medium by the memory medium driving module is set by the upper device,
the selection module selects the speed information satisfying a predetermined condition by the process time as the one of the plurality of speed information on the basis of the driving time; and
the control module controls the memory medium driving module to drive the memory medium only for the driving time.

18. The memory device for the memory device of claim 17, wherein the selection module selects the speed information, which allows the process time to be smaller than or equal to the driving time or to be maximum value, as the one of the plurality of speed information.

19. A control method applied to a memory device configured to drive a writing module to write data in a memory medium, comprising:
obtaining a data group of a plurality of data to be written in the memory medium from an upper device;
storing the data group in the memory module;
managing management information about the data group;
retaining a plurality of speed information, each of the plurality of speed information corresponding to different speed of a swing module configured to swing the writing module;
acquiring at least one of speed information among the plurality of speed information;
calculating a process time taken to write the data group when the acquired speed information is used;
selecting one of the plurality of speed information on the basis of the acquired speed information and the process time corresponding to the acquired speed information;
controlling a memory medium driving module driving the memory medium;
controlling the writing module to write the data group when the memory medium driving module is in operation;
storing the data group in the memory module when the memory medium driving module is not in operation;
controlling the swing module on the basis of the selected speed information; and
controlling the writing module to write the data group stored in the memory module.

20. The control method of claim 11, wherein
the calculating includes calculating a writing order of the plurality of data for the case of using the acquired speed information on the basis of the management information and the acquired speed information; and
the controlling the writing module includes controlling the writing module to write the data group stored in the memory module on the basis of the writing order.
